(19) United States
(12) Patent Application Publication
(10) Pub. No.: US 2013/0185567 A1
(43) Pub. Date: Jul. 18, 2013

(54) Method or process for securing computers or mobile computer devices with a contact or dual-interface smart card

(71) Applicant: Greg Salyards, Austin, TX (US)

(72) Inventor: Greg Salyards, Austin, TX (US)

(21) Appl. No.: 13/350,450

(22) Filed: Jan. 13, 2012

(51) Int. Cl. G06F 21/00

(52) U.S. Cl. 713/185

(57) ABSTRACT

A method or system providing for the persistence of a computer session upon removal of a contact or dual-interface smart card from a smart card reader and locking, logging off, or disconnecting from the session when the contact or dual-interface smart card is re-presented to the smart card reader.

### BACKGROUND OF INVENTION

1. Technical Field

The system and apparatus described in this disclosure pertains to communications between a contact or dual-interface smart card and a computer or mobile computing device that allows for the persistence of the current session upon removal of the smart card from the smart card reader and locking, logging off, or disconnecting from the session when the contact or dual-interface smart card is re-presented to the smart card reader.

2. Related Technology

In today's world the threat of identity theft and unauthorized access to confidential and proprietary information in a digital form has forced owners of stand-alone and network based computer systems to adopt stronger forms of authentication in order to prevent unauthorized access to personal, corporate and government digital information.

User names and passwords initially served as a valid means for protecting digital information. However, due to the growth of computer processing power, social networking, personnel complacency with security policy and other threats, organizations were forced to strengthen standard user names and passwords to such an extent that they have now become unusable, expensive to maintain and, in many cases, ineffectual in achieving the desired increase in security.

As an alternative to user names and passwords, organizations have started to adopt stronger forms of authentication known as two-factor, three-factor and four-factor authentication, such as contact based smart cards, biometric devices, Knowledge-Based Authentication (KBA), identity validation services and One-Time Password tokens. These newer authentication methods are grouped into various factors of authentication: physical non-human devices are referred to as “something you have,” human biometrics are referred to as “something you are,” human memory is referred to as “something you know” and personal validation of public records or third-party verification services and the alike are referred to as “something somebody else knows about you.”

In recent years organizations have begun to adopt mechanisms known as smart card technology for authenticating users to computers and mobile devices. A smart card, chip card, or integrated circuit card (ICC) is any pocket-sized card with embedded integrated circuits. A smart card or microprocessor card contains volatile memory and microprocessor components. The card is made of plastic, generally polyvinyl chloride but sometimes acrylonitrile butadiene styrene or polycarbonate. Smart cards may also provide strong security authentication for single sign-on (SSO) within large organizations.

Cryptographic smart cards are often used for single sign-on. Most advanced smart cards include specialized cryptographic hardware that uses algorithms such as RSA and Triple DES. Today's cryptographic smart cards generate key pairs on board to avoid the risk from having more than one copy of the key (since by design there usually isn't a way to extract private keys from a smart card). Such smart cards are mainly used for digital signature and secure identification.

The most common ways to access cryptographic smart card functions on a computer are to use a vendor-provided PKCS#11 library or a Cryptographic Service Provider (CSP) on Microsoft Windows.

The most widely used cryptographic algorithms in smart cards (excluding the GSM so-called “crypto algorithm”) are Triple DES and RSA. The key set is usually loaded (DES) or generated (RSA) on the card at the personalization stage. Some of these smart cards are also made to support the NIST standard for Personal Identity Verification, FIPS 201.

While smart cards are the single most common form-factor for this technology, smart card technology can also be present in other form-factors, such as a USB memory token, a key fob, or embedded in or inserted into a mobile phone. For the purposes of this patent, the term smart card will encompass all of these technologies as well as dual-interface smart cards which process communications over a contactless antennae, also known as RFID. Dual-interface cards implement contactless and contact interfaces on a single card with some shared storage and processing. A dual interface card uses a chip with both contact and contactless (ISO/IEC 14443 Type B) interfaces.

Due to their universal and ubiquitous nature, contactless smart cards are ideal for use as a two-factor logon device to network systems. In so doing, organizations will desire to force their employees to logon with only their contactless smart cards and eliminate the ability to logon with their legacy username-and-password pairs. These contactless or proximity (RFID) cards are uniquely different than contact smart cards since they are not capable of performing cryptographic operations on the card and in some cases are not capable of storing information. Single-interface contactless or proximity RFID cards are considered out of scope for this invention.

At its simplest form, the smart card login process requires a user to insert a smart card or present a dual-interface smart card to a smart card reader. Once inserted or presented, the user must enter a PIN to unlock the secret container located on the smart card chip. Once unlocked, cryptographic processes take place to validate the user's certificate and associated keys. Once validated, the user is permitted to logon to the computer operating system or mobile device.

The core component of this patent involves what happens after the login process occurs. Standard processes with post-smart card logon to computers and mobile devices involve something known as smart card removal behavior. The smart card removal behavior governs what will happen, if anything, when the smart card is removed from the smart card reader. In most instances, and in the case of Microsoft operating systems, a policy is set to take action upon removal of the smart card from the smart card reader. These actions include (1) locking the computer or mobile device, (2) logging the user off the current session within the computer or mobile device, or (3) disconnecting the user from a remote session within the computer or mobile device.

Current smart card removal behavior policies do not take into account standard user behavior. Historically, it was expected that the user would simply carry the smart card in a holder, remove the card from the holder when needed, and insert the card into the smart card reader. Over the years users have pushed back on this concept since it creates a number of unacceptable scenarios, e.g., the user leaving the smart card in the smart card reader when she walks-away from the system, slowing the user down in situations where she logs on to systems hundreds of times per day, or presenting cross contamination concerns from inserting smart cards into multiple smart card readers.

Current processes for contact smart cards do not take into consideration the possibility of users simply inserting or presenting their smart card to a smart card reader to initiate what is described above for smart card removal behavior. In essence, the process is transitioned from a traditional security posture, which insured the smart card remained in the reader during the session, to a convenience posture by allowing the user to insert or present the smart card to the smart card reader to trigger the desired lock, logoff, or disconnect event.

When a smart card is presented to a smart card reader a personal computer/smart card (PC/SC) event is triggered. This event is also triggered when the card is removed from the reader and is essentially the stimulus that notifies the system to execute the smart card removal behavior. The invention described herein will require a listener to be created and installed on the computer or mobile device that listens to PC/SC events and executes a policy (lock, logoff, disconnect) in the event the smart card is removed or inserted/presented to a smart card reader post-login and after the contact or dual-interface smart card was initially removed from the smart card reader. The listener will monitor all PC/SC events, those requests coming from the smart card reader as well as requests from other applications. Other application PC/SC events may include an application requesting the smart card be presented or inserted into the reader to perform a digital signature or encryption routine. This event will be ignored by the listener and will not trigger the lock, logoff, or disconnect event.

This invention is designed to override the PC/SC triggering mechanism so as to allow for the persistence of the computer or mobile device session on removal of the smart card from the smart card reader and for desired behavior when the smart card is reinserted or represented to the smart card reader.

### SUMMARY OF INVENTION

A method or system providing for the persistence of a computer session upon removal of a contact or dual-interface smart card from a smart card reader and locking, logging off, or disconnecting from the session when the contact or dual-interface smart card is re-presented to the smart card reader.

### SUMMARY OF DRAWINGS

The features of the invention are believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 illustrates the introduction of the smart card to the smart card reader for the creation of a new session or to reconnect to an existing session.

FIG. 2 illustrates the persistence of the current session on removal of the smart card from the smart card reader.

FIG. 3 illustrates the introduction of the smart card to the smart card reader upon request from another cryptographic process.

FIG. 4 illustrates the user-initiated reintroduction of the smart card to the smart card reader (no request from another cryptographic process).

FIG. 5 illustrates the removal of the smart card from the smart card reader after performance of the predefined Smart Card Removal Policy (SCRP).

### DETAILED DESCRIPTION OF INVENTION

A contact or dual-interface smart card (“smart card”) and smart card reader are designed to provide security when used in connection with a personal computer or mobile computing device. The smart card must be presented for user authentication before the user is allowed access to the PC or mobile computing device. With current technology, the smart card must remain in contact with the smart card reader at all times after successful logon and a policy must be set, on either the local system or within the domain environment in which the user is logged on, in order for smart card removal behavior to occur upon removal of a smart card. This invention provides for the persistence of the current session upon removal of the smart card from the smart card reader and locking, logging off, or disconnecting from the session when the contact or dual-interface smart card is re-presented to the smart card reader.

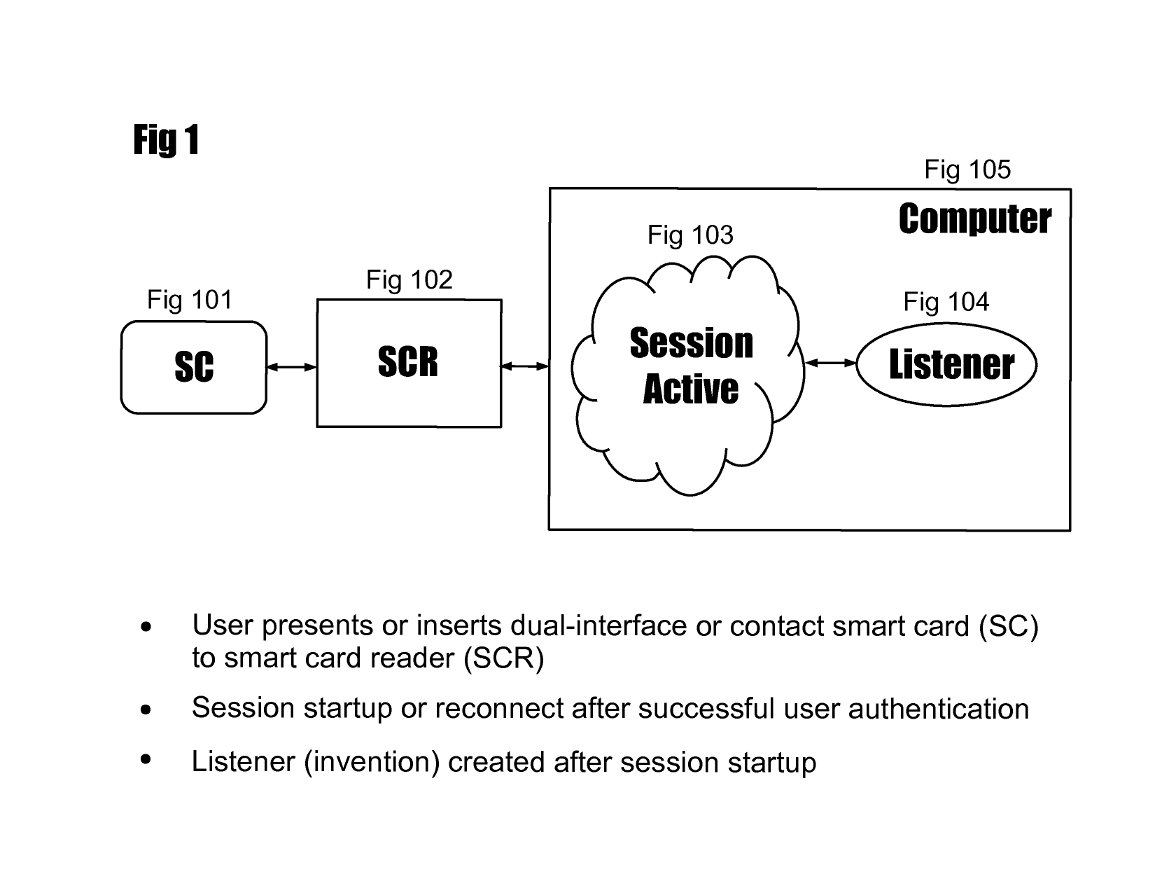

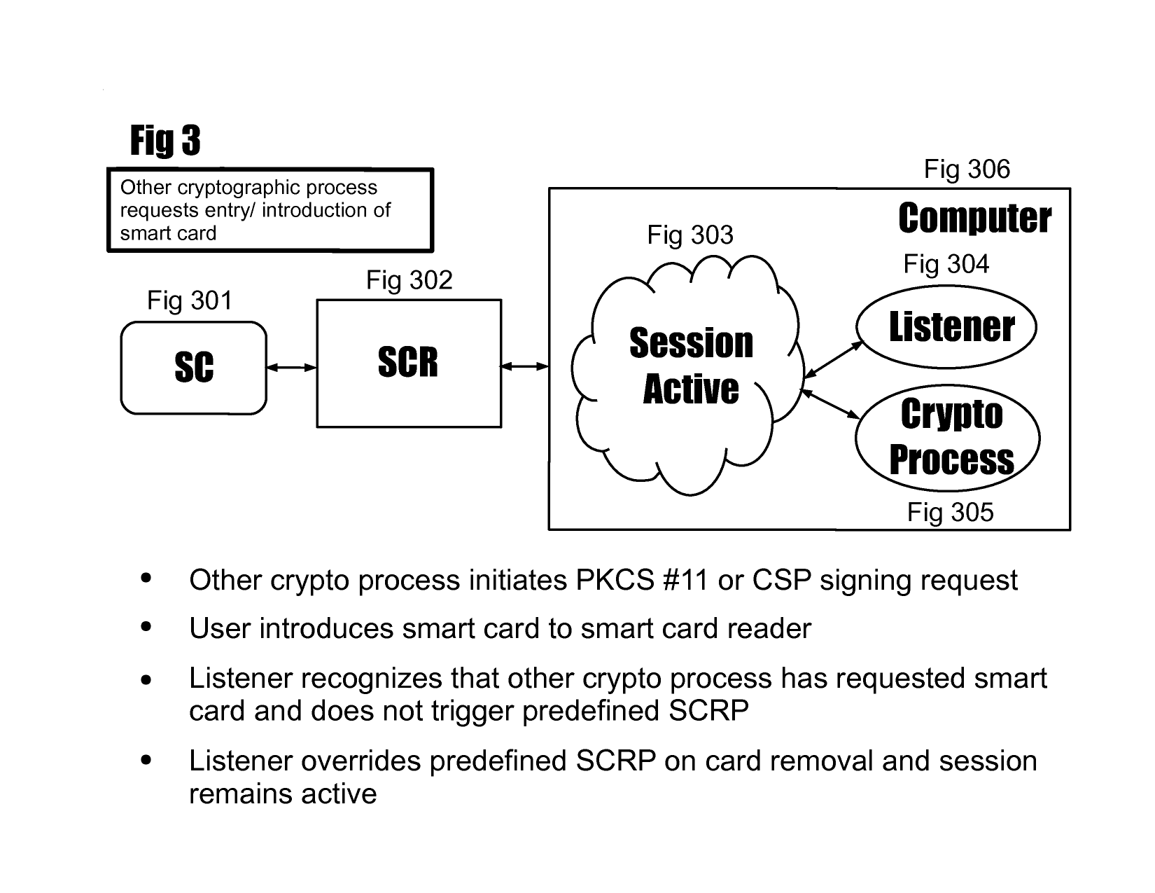

After a session is successfully started, a listener (the invention) is created on the PC or mobile computing device (FIG. 1) to monitor personal computer/smart card (PC/SC) events and to insure that desired behavior is effected upon introduction/removal of the smart card. In addition to smart card introduction/removal, PC/SC events will also occur in response to requests from other cryptographic processes needing access to information on the smart card (FIG. 3).

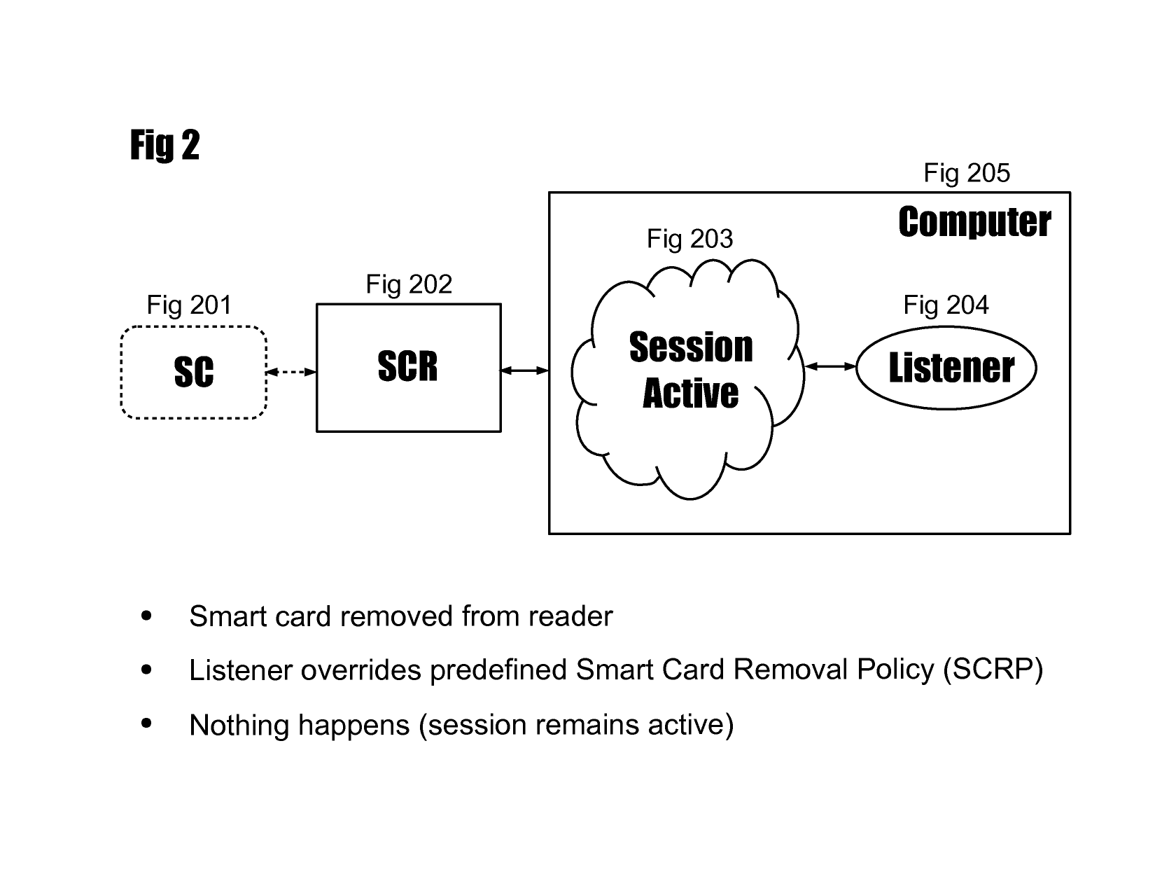

After successful logon and upon removal of the smart card from the smart card reader, the listener will override predefined smart card removal policy and allow the session to remain active without requiring the presence of the smart card (FIG. 2).

When another cryptographic process requests information from the smart card, the listener will recognize the source of the request and will not trigger smart card removal behavior upon introduction of the smart card (FIG. 3). When the requesting process no longer needs the smart card, the listener will permit its removal from the smart card reader by suppressing predefined removal behavior and allowing the session to remain active.

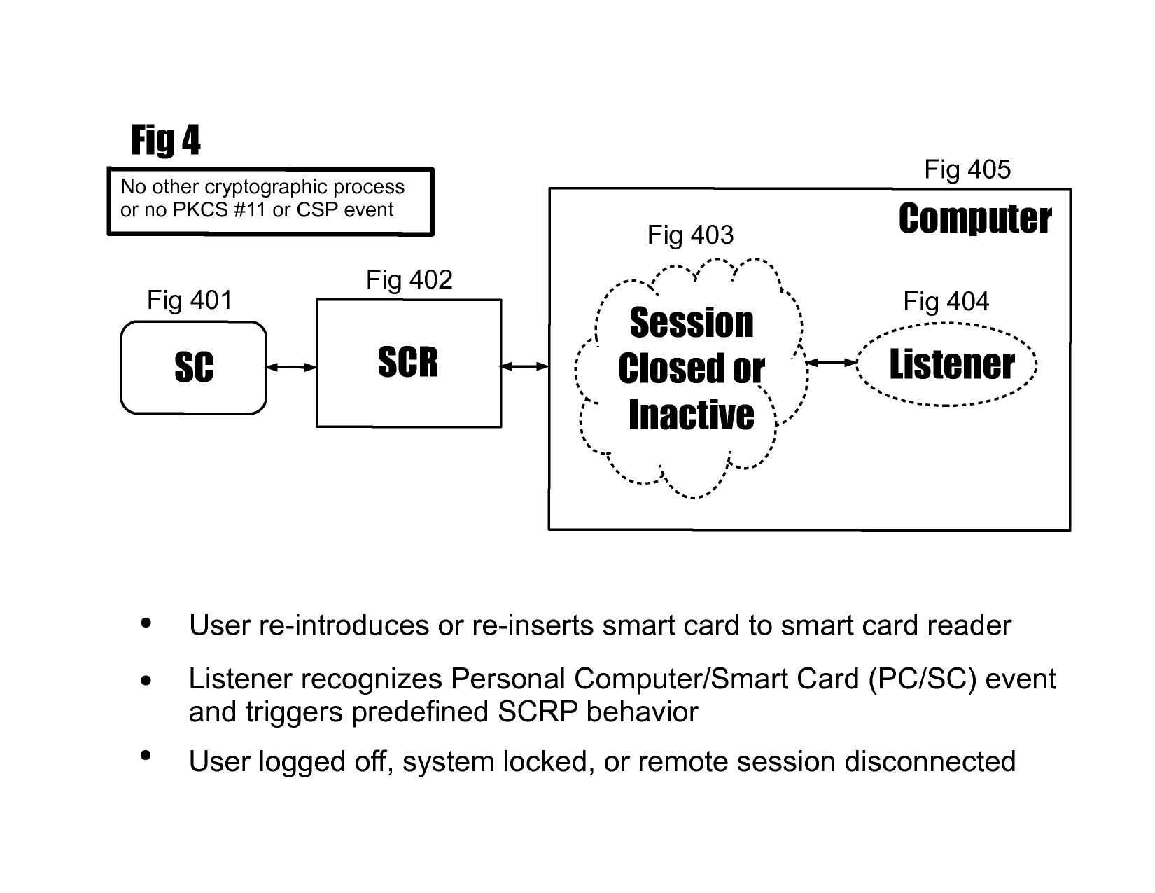

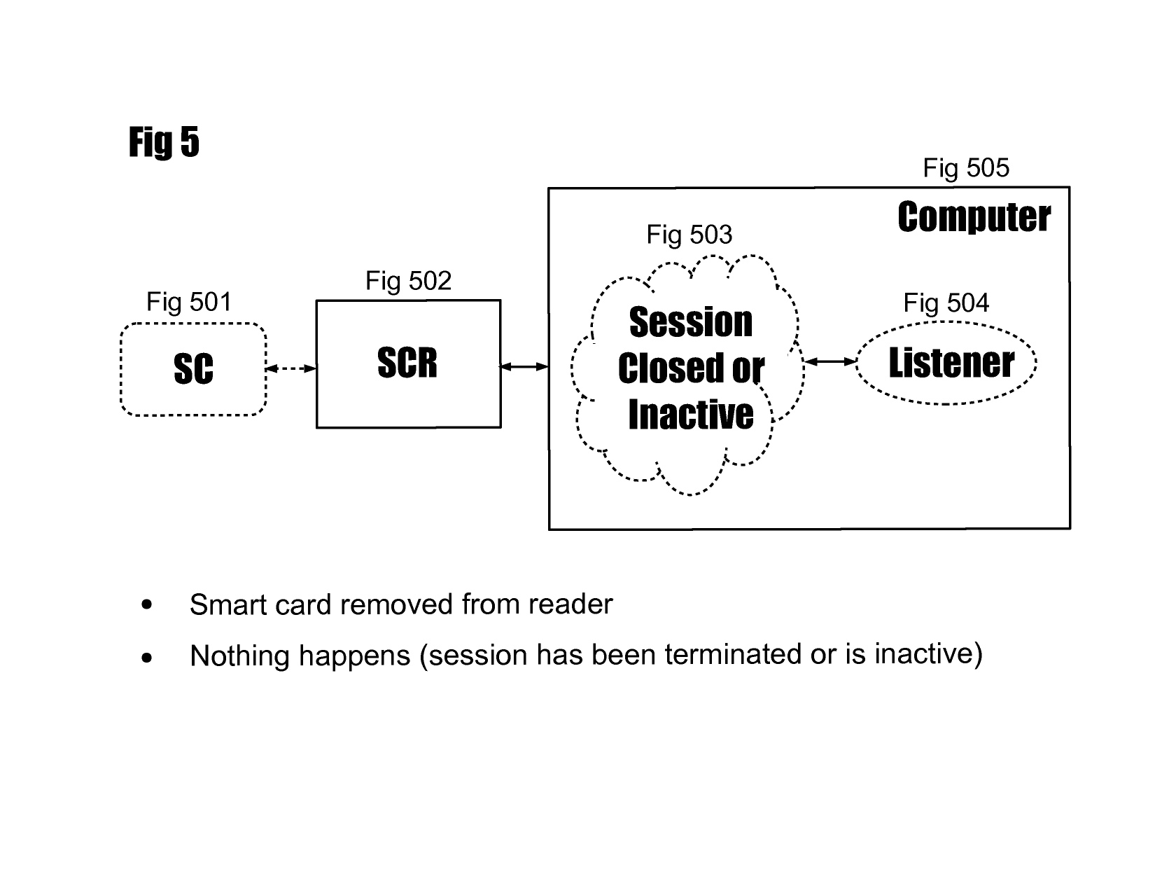

When the user wishes to lock, logoff, or disconnect from her session (FIG. 4), she simply inserts or presents her smart card to the smart card reader. The listener will recognize the introduction of the smart card and that no other cryptographic process has requested it and will trigger predefined smart card removal behavior (logoff session, lock session, disconnect from remote session). Removal of the smart card after this will have no effect as the session has been terminated or is inactive (FIG. 5).

1. A method allowing for the persistence of a personal computer or mobile computing device session upon removal of a contact or dual-interface smart card from the smart card reader and locking, logging off, or disconnecting from the session when the contact or dual-interface smart card is re-presented to the smart card reader.

2. A system of claim 1 consisting of
(a) a contact or dual-interface smart card;
(b) a contact or dual-interface smart card reader;
(c) a computer or mobile computing device; and
(d) a listener process on the computer or mobile computing device.

3. The method of claim 2 wherein said listener is a service monitoring Personal Computer/Smart Card (PC/SC) events that makes decisions based upon predefined policies.

4. The method of claim 3 wherein said listener overrides predefined card removal policy on removal of the smart card from the smart card reader and allows the current session to remain active.

5. The method of claim 3 wherein said listener recognizes a PKCS#11 or CSP signing request from a secondary cryptographic process and prevents predefined smart card removal policy on re-presentation of the contact or dual-interface smart card to the smart card reader.

6. The method of claim 3 wherein said listener recognizes that no other cryptographic process has requested the smart card and on re-presentation of the smart card to the smart card reader initiates predefined smart card removal policy, resulting in locking, logging off, or disconnecting from the current session.
